(19) United States
(12) Patent Application Publication
(10) Pub. No.: US 2007/0128553 A1
(43) Pub. Date: Jun. 7, 2007

(54) METHOD FOR FORMING FEATURE DEFINITIONS

(76) Inventor: JOERG LINZ, Dresden (DE)

Correspondence Address: PATTERSON & SHERIDAN, LLP, 3040 POST OAK BOULEVARD, SUITE 1500, HOUSTON, TX, 77056, US

(21) Appl. No.: 11/551,110

(22) Filed: Oct. 19, 2006

Related U.S. Application Data
(60) Provisional application No. 60/728,284, filed on Oct. 19, 2005.

(51) Int. Cl. G03C 5/00

(52) U.S. Cl. 430/311

(57) ABSTRACT

Methods are provided for processing a substrate by depositing a negative mask material on a surface of the substrate, etching the negative mask material to the substrate surface to form negative mask feature definitions, depositing an etch resistant material in the negative mask feature definitions, polish the etch resistant material to expose the negative mask materials, and etching the negative mask material to form feature definitions in the etch resistant material.

### CROSS-REFERENCE TO RELATED APPLICATIONS

This application claims benefit of U.S. provisional patent application Ser. No. 60/728,284, filed Oct. 19, 2005, which is herein incorporated by reference.

### BACKGROUND OF THE DISCLOSURE

1. Field of the Invention

The invention relates to the fabrication of integrated circuits and to a process for forming feature definitions on substrate surfaces.

2. Description of the Related Art

Semiconductor device geometries have dramatically decreased in size since such devices were first introduced several decades ago. Since then, integrated circuits have generally followed the “two year/half-size rule” (often called Moore's Law), which means that the number of devices that will fit on a chip doubles every two years. Today's fabrication plants are routinely producing devices having 0.35 μm and even 0.18 μm feature sizes, and tomorrow's plants soon will be producing devices having even smaller geometries. Additionally as the feature sizes have become smaller, the aspect ratio, or the ratio between the depth of the feature and the width of the feature has steadily increased, such that manufacturing processes are being required to deposit materials in features having aspect ratios of about 100:1 or greater.

Traditionally, features having aspect ratios of about 10:1 or so were produced by depositing a resist material on a dielectric material, and then etching the dielectric layer to form the feature definition used to create the feature. However, resist materials have been found to have limited etch selectivity to the dielectric material. Selectivity is a ratio of the removal rate of the resist material to the dielectric material. If a resist material does not have sufficient selectivity the resist material may be overetched, and the dimensions of the underlying features being etched may in turn be overetched. For example, a 0.18 μm feature may be formed having a width of 0.24 μm and become unsuitable for its intended purpose. Incorrectly formed feature dimensions can lead to features that suffer from subsequent device failure.

One solution to improving etch selectivity is to form a hardmask material between the photoresist and the underlying dielectric material. The hardmask is patterned by the photoresist and the hardmask is used to provide the desired selectivity during the etching process for the dielectric material. However, current hardmask material may lack the selectivity to form features having aspect rations of 100:1 or greater. Further, the pattern being transferred from the resist material to the hardmask to the dielectric material may be mistranslated resulting in undesirable feature definitions. Additionally, the use of a hardmask increases production time and costs as additional steps are required for feature formation.

Therefore, there remains a need for an improved process and material for depositing and patterning dielectric materials for feature formation.

### SUMMARY OF THE INVENTION

Embodiments of the present invention generally provide methods for forming feature definitions on substrate surfaces.

Embodiments of the invention generally provide a method for processing a substrate including depositing a negative mask material on a surface of the substrate, depositing a resist material on the negative mask material, patterning the resist material to expose the negative mask material, etching the exposed negative mask material to form negative mask feature definitions, removing the resist material, depositing an etch resistant material in the negative mask feature definitions and on the negative mask material, polishing the etch resistant material to expose the negative mask materials, and etching the negative mask material to form feature definitions in the etch resistant material.

Another embodiment of the invention generally provides a method for processing a substrate including depositing a barrier layer on the substrate, depositing a first negative mask material on the barrier layer, depositing a first resist material on the first negative mask material, patterning the first resist material to expose the first negative mask material, etching the exposed first negative mask material to form first negative mask feature definitions, removing the first resist material, depositing a first etch resistant material in the first negative mask feature definitions and on the first negative mask material, polishing the first etch resistant material to expose the first negative mask materials, and etching the first negative mask material to form feature definitions in the first etch resistant material. The method further includes depositing a second negative mask material on the negative mask material and the etch resistant material, patterning the second resist material, etching the exposed second negative mask material to the substrate surface to form second negative mask feature definitions, removing the resist material, depositing a second etch resistant material in the second negative mask feature definitions, polishing the second etch resistant material to expose the second negative mask material, and etching the first and second negative mask materials to form feature definitions in the first and second etch resistant materials.

Another embodiment of the invention generally provides a method for processing a substrate including depositing a negative mask material on a surface of the substrate, depositing a resist material on the negative mask material, patterning the resist material to expose the negative mask material, etching the exposed negative mask material to form negative mask feature definitions, removing the resist material, depositing an etch resistant material in the negative mask feature definitions and on the negative mask material, polishing the etch resistant material to expose the negative mask materials, etching the negative mask material to form feature definitions in the etch resistant material, and patterning the substrate.

### BRIEF DESCRIPTION OF THE DRAWINGS

So that the manner in which the above features of the invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a flow chart of one embodiment of a damascene formation sequence of the invention;

FIG. 2 is a flow chart of another embodiment of a damascene formation sequence of the invention;

FIGS. 3-10 are cross sectional views showing one embodiment of a damascene formation sequence of the invention;

FIGS. 11-16 are cross sectional views showing another embodiment of a damascene formation sequence of the invention; and

FIG. 17 is a flow chart of one embodiment of a process sequence of the invention.

To facilitate understanding, identical reference numerals have been used, wherever possible, to designate identical elements that are common to the figures. It is contemplated that elements and/or process steps of one embodiment may be beneficially incorporated in other embodiments without additional recitation.

### DETAILED DESCRIPTION OF THE PREFERRED EMBODIMENTS

The words and phrases used herein should be given their ordinary and customary meaning in the art by one skilled in the art unless otherwise further defined.

As used herein the term “in-situ” should be broadly construed and includes, but is not limited to, in a given chamber, such as in a plasma chamber, or in a system, such as an integrated cluster tool arrangement, without exposing the material to intervening contamination environments, such as breaking vacuum between process steps or chamber within a tool. An in-situ process typically minimizes process time and possible contaminants compared to relocating the substrate to other processing chambers or areas.

As used herein, the term “substrate” generally refers to any substrate or material surface formed on a substrate upon which film processing is performed. For example, a substrate on which processing can be performed includes materials such as silicon, silicon oxide, strained silicon, silicon on insulator (SOI), carbon doped silicon oxides, silicon nitride, doped silicon, germanium, gallium arsenide, glass, sapphire, and any other materials such as metals, metal nitrides, metal alloys, and other conductive materials, depending on the application. Barrier layers, metals or metal nitrides on a substrate surface include titanium, titanium nitride, tungsten nitride, tantalum, and tantalum nitride. Substrates may have various dimensions, such as 200 mm or 300 mm diameter wafers, as well as, rectangular or square panes. Substrates on which embodiments of the invention may be useful include, but are not limited to semiconductor wafers such as crystalline silicon (e.g., Si<100>or Si<111>), silicon oxide, strained silicon, silicon germanium, doped or undoped polysilicon, doped or undoped silicon wafers and patterned or non-patterned wafers.

As used herein, the term “chemical mechanical polishing” should be broadly construed and includes, but is not limited to, planarizing a substrate surface using chemical activity and mechanical activity, or a concurrent application of chemical activity and mechanical activity.

As used herein, the term “electrochemical mechanical polishing” (Ecmp) should be broadly construed and includes, but is not limited to, planarizing a substrate by the application of electrochemical activity, mechanical activity, chemical activity, or a concurrent application of a combination of electrochemical, chemical, and/or mechanical activity to remove material from a substrate surface.

Aspects of the invention described herein refer to method for forming feature definitions, such as damascene and dual damascene features by depositing and etching a negative mask material. While the specification is described with regard to damascene features, the invention contemplates forming other semiconductor structures that may require high aspect ratios, i.e., aspect ratios of about 30:1 or greater, for example, high aspect ratio DRAM structures, may be formed by the processes described herein.

The processes described herein are preferably performed in a processing chamber adapted to deposit dielectric material, which may be by a process including the application of RF power, such as the DXZ™ chemical vapor deposition chamber or the 300 mm Producer™ dual deposition station processing chamber, both of which are commercially available from Applied Materials, Inc., Santa Clara, Calif. An example of a CVD reactor that may be used with the processes herein is described in U.S. Pat. No. 5,000,113, entitled A Thermal CVD/PECVD Reactor and Use for Thermal Chemical Vapor Deposition of Silicon Dioxide and In-situ Multi-step Planarized Process, issued Mar. 19, 1991 to Wang et al. and assigned to Applied Materials, Inc., the assignee of the present invention. In this experiment, the Producer™ deposition chamber is used. The etching processes described herein are preferably performed in a processing chamber adapted to chemically etch deposited material while applying RF power, such as the DPS™ etch chamber, or an Enabler™ etching system or the Super E™ etching system, all of which are commercially available from Applied Materials, Inc., Santa Clara, Calif.

Deposition of Dual Damascene Structure

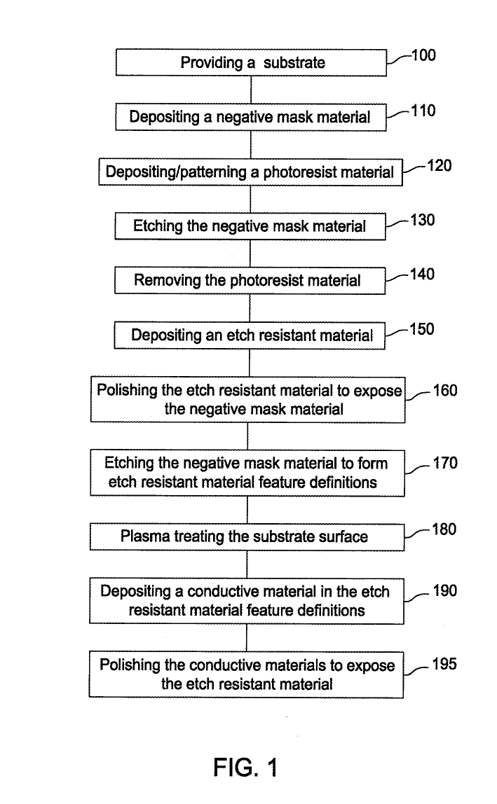

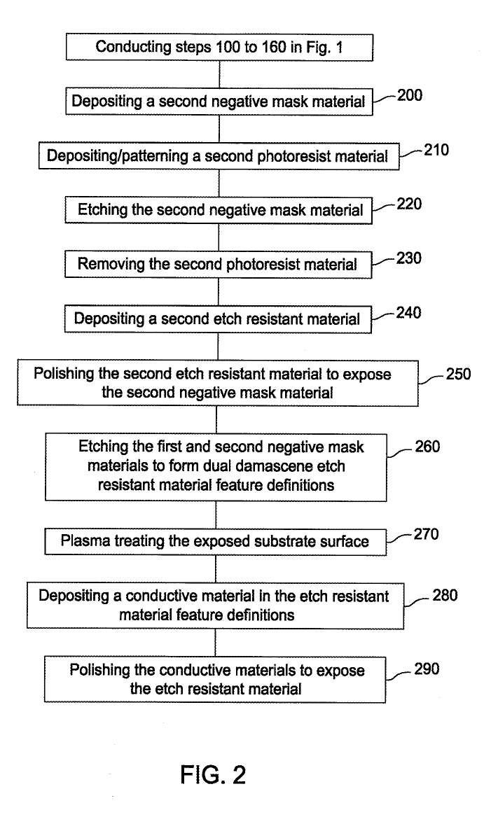

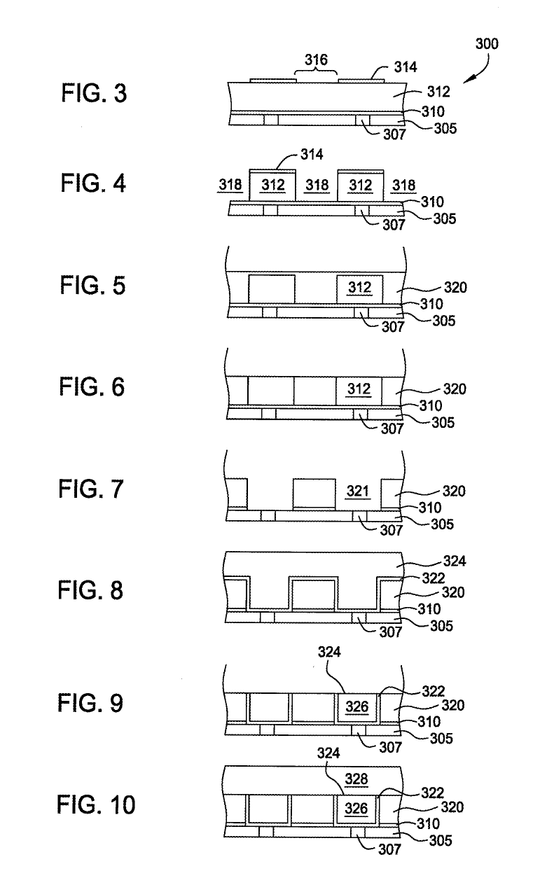

One embodiment of a damascene structure fabricated in accordance with the invention including the negative mask material and etch resistant material described herein is sequentially depicted schematically in FIG. 1 and FIGS. 3-10. FIGS. 3-10 are cross sectional views of a substrate having the Steps 100-195 of the flowchart of FIG. 1 performed thereof. The flow chart of FIG. 1 is provided for illustrative purposes and should not be construed as limiting the scope of the invention.

A substrate 300 is provided in Step 100 of FIG. 1 and as illustrated in FIG. 3. An optional barrier layer 310 such as silicon carbide based barrier layer is deposited on the surface of the substrate 305. The substrate surface comprises conductive features 307 disposed in a doped silicon substrate or material such as glass, thermal oxide, quartz or other materials conventionally used in semiconductor fabrication. The conductive features 307 may be prior deposited damascene structures or conductive components of a transistor. The conductive features 307 may comprise conductive materials, such as polysilicon, or refractory metals, such as copper, tungsten, and other refractory metals used in the formation of semi-conductor devices.

The substrate barrier layer 310 is conformally deposited on the substrate 305 to prevent interlayer diffusion of materials into the substrate 305. The barrier layer 310 can also act as an etch stop to protect the substrate during etching and removal of subsequent layers that may be deposited thereon. The barrier layer 310 may comprise a dielectric barrier material including silicon nitride or low dielectric constant (Low k) dielectric material, such as a silicon carbide based material. The silicon carbide material may comprise silicon carbide, a nitrogen doped silicon carbide material, an oxygen containing silicon carbide layer, and/or a phenyl containing silicon carbide material. The barrier layer 310 may further be doped with boron, phosphorus, or combinations thereof.

Alternatively, the barrier layer 310 may comprise a bi-layer of material, such as a layer of nitrogen containing silicon carbide material followed by a layer of nitrogen-free silicon carbide material. The nitrogen containing silicon carbide material and the nitrogen-free silicon carbide material may be deposited in-situ. The barrier layer 310 may be plasma treated or exposed to an e-beam treatment after deposition. The plasma treatment may be performed in-situ with the deposition of the barrier layer 310 material.

A negative mask material layer 312 is deposited on the barrier layer 310 at Step 110 and as illustrated in FIG. 1. The negative mask material may be deposited to a thickness between about 1,000 and about 15,000 Å depending on the size of the structure to be fabricated. Suitable negative mask materials are materials that may be etched using conventional dielectric dry-etching or plasma-etching techniques. Desirable negative mask materials include those that can be etched using conventional plasma etching process, that are not removed or damaged by subsequent deposition process, and that are resistant to being polished. Examples of suitable negative mask materials include polysilicon, amorphous silicon, silicon nitride, silicon carbide as described herein, amorphous carbon, a low polymer material, such as parylene, and oxides, including silicon oxide and carbon doped silicon oxides such as Black Diamond™ dielectric material commercially available from Applied Materials, Inc., of Santa Clara, Calif., or a low k spin-on glass such as un-doped silicon glass (USG) or fluorine-doped silicon glass (FSG), or combinations thereof. An example of the dielectric material for the negative mask material layer 312 and process for deposition the dielectric material is more fully described in U.S. Pat. No. 6,287,990, entitled “CVD Plasma Assisted Low Dielectric Constant Films,” issued on Sep. 11, 2001, which is incorporated by reference herein to the extent not inconsistent with the description and claims herein.

The negative mask material layer 312 may then be treated by a plasma process or e-beam technique to remove contaminants and densify the surface of the negative mask material layer 312. Alternatively, the negative mask material layer 312 may include one or more layers of dielectric material with one or more etch stop or barrier layers of dielectric material disposed therein to help form and define the dual damascene definition.

As illustrated in FIG. 3, a resist material 314, such as a photoresist material, is then deposited on the negative mask material 312, and the resist material is patterned preferably using conventional photolithography processes at Step 120 to define the horizontal component 316 of negative mask feature definitions. The resist material 314 may comprises a material conventionally known in the art, for example, a high activation energy photoresist, such as UV-5, commercially available from Shipley Company Inc., of Marlborough, Mass., or an electron beam (e-beam) resist used in e-beam pattering techniques.

The negative mask material 312 is then etched using reactive ion etching or other conventional etching techniques to define the negative mask feature definitions 318 at Step 130 and as illustrated in FIG. 4. An example of etching a suitable negative mask material, such as silicon oxide, is more fully described in U.S. Pat. No. 5,843,847, entitled “Method for Etching Dielectric layers with High selectivity and Low Microloading,” issued on Dec. 1, 1998, which is assigned to Applied Materials, Inc., and incorporated herein by reference to the extent not inconsistent with the invention. One example of patterning the negative mask material 312 was performed using an Enabler™ etching system. The chamber pressure was maintained at 20 mTorr, a flow rate of O₂ was maintained at 80 sccm, a flow rate of C₄F₆ was maintained at 80 sccm, an argon flow rate was maintained at 600 sccm, and a plasma was generated by applying a RF voltage having a power level of between about 1900 watts and 2500 watts. Any resist material 314 or other material used to pattern the negative mask material 312 is removed using an oxygen strip or other suitable process at Step 140.

An etch resistant material 320 is then deposited on the substrate 300 to fill in the negative mask feature definitions 318 at Step 150 as illustrated in FIG. 5. The etch resistant material may comprise a ceramic material including aluminum oxide, aluminum carbide, or combinations thereof. The etch resistant material is typically resistant to plasma etching processes, also known as dry-etching processes which use etching gases with plasma enhanced processes to etch material from a substrate surface. Desirable etch resistant materials are materials resistant to plasma etching processes, that are not removed or damaged by subsequent deposition process, and that can be polished using conventional polishing techniques, such as chemical mechanical polishing. Other etch resistant materials include carbides, such as aluminum carbide, titanium carbide, zirconium carbide, and tantalum carbide, oxides, such as aluminum oxide, hafnium oxide, zirconium oxide, lanthanum oxide, yttrium oxide, nitrides, such as aluminum nitride, lanthanum nitride, tantalum nitride, and zirconium nitride, noble metals, such as gold, silver, platinum, and other metals, such as lead and titanium.

The etch resistant material 320 is then polished to expose the underlying negative mask material 312 at Step 160 as illustrated in FIG. 6. The polishing process may be any conventional chemical mechanical polishing process or an electrochemical mechanical polishing process if possible, known in the art for removing such materials.

The remaining negative mask material 312 is then etched using reactive ion etching or other conventional etching techniques, such as described herein at Step 130, to be removed from the substrate and define the etch resistant material feature definitions 321 at Step 170 and as illustrated in FIG. 7. One example of removing the negative mask material 312 was performed using the Applied Centura eMAX Etch system. The chamber pressure was maintained at 100 mTorr, a flow rate of CF₄ was maintained at 60 sccm, a flow rate of CHF₃ was maintained at 90 sccm, an argon flow rate was maintained at 600 sccm, and a plasma was generated by applying a RF voltage having a power level of about 3000 watts. The optional barrier layer 310 may also be etched to expose the underlying conductive features 307 disposed in the substrate.

Optionally, the substrate may then be exposed to a reactive pre-clean process at Step 180 to remove some oxides and other contaminants, such as etch residue and metal contaminants, in the definition 321 and on the surface of the substrate, which may interfere with subsequent layer deposition. One example of a reactive pre-clean process comprises exposing the substrate surface to a plasma, preferably comprising ammonia, hydrogen and/or an inert gas, such as argon, at a power density between of 0.03 watts/cm² and about 3.2 watts/cm², or at a power level between about 10 watts and 1000 for a 200 millimeter substrate with the processing chamber is maintained at a pressure of about 20 Torr or less and at a substrate temperature of about 450° C. or less during the reactive clean process. The reactive pre-clean described herein can be used to remove oxides formed on metal layers, such as the conductive barrier layers and conductive material layers, as well as oxides formed in the etch resistant material.

Conductive fill materials including a barrier layer 322 are deposited on the exposed surface of the feature definition 321 and a conductive material layer 324 is deposited upon the barrier layer 322 at Step 190 as shown in FIG. 8. The barrier layer 322 is deposited on exposed surfaces of the feature definition 321 to prevent interlayer diffusion, such as copper migration into the surrounding dielectric material, and to improve adhesion between the etch resistant material 320 and the subsequently deposited layers, such as the conductive material layer 324. The barrier layer 322 may be formed by a thermal or plasma enhanced chemical vapor deposition process, or alternatively, deposited by a physical vapor deposition process, such as an ionized metal plasma physical vapor deposition process (IMP-PVD). Preferably, the barrier layer 322 comprises materials selected from the group of titanium, titanium nitride, titanium silicon nitride, tungsten nitride, tungsten silicon nitride, tantalum, tantalum nitride, tantalum silicon nitride, niobium, niobium nitride, vanadium, vanadium nitride, ruthenium, ruthenium nitride, and combinations thereof.

The conductive material layer 324 is deposited to fill the at least a portion of the feature definition 321, and is preferably deposited to fill the feature definition 321, and may be deposited to several angstroms thick on the substrate, called overburden, to ensure fill of the feature definition 321. Alternatively, the conductive material layer 324 comprises a seed layer of a conducting metal to fill at least a portion of the feature definition 321 and a subsequent metal fill layer on the seed layer. The conductive material layer 324 preferably comprises copper or aluminum, and may be doped with phosphorous and/or boron, to improve deposition. The conductive material layer 324 may be deposited by a chemical vapor deposition (CVD) technique, a physical deposition (PVD) technique, such as ionized metal plasma (IMP) PVD, electroplating, electroless deposition, evaporation deposition, or any other process conventionally known in the art. Preferably, the conductive material layer 324 comprises copper and is deposited using an electroplating technique. An exemplary electroplating method is described in U.S. Pat. No. 6,113,771, entitled “Electro Deposition Chemistry, issued on Sep. 5, 2000, which is assigned to Applied Materials, Inc., and is incorporated herein by reference to the extent not inconsistent with the invention.

The deposited barrier layer and conductive materials may be further processed by planarizing the top portion of the feature definition 321 to expose the etch resistant material 320 and to form feature 326 by a chemical mechanical polishing process or electrochemical mechanical polishing process at Step 195 as shown in FIG. 19. An example of an electrochemical polishing process is described in co-pending U.S. patent application publication No. 2003/0178320, published on Sep. 25, 2003, which is assigned to Applied Materials, Inc., and is incorporated herein by reference to the extent not inconsistent with the invention.

A passivation layer 328, such as a dielectric barrier material as used for barrier layer 310 may be deposited over the planarized substrate surface as shown in FIG. 10.

Deposition of a Dual Damascene Structure with Sacrificial Dielectric Material

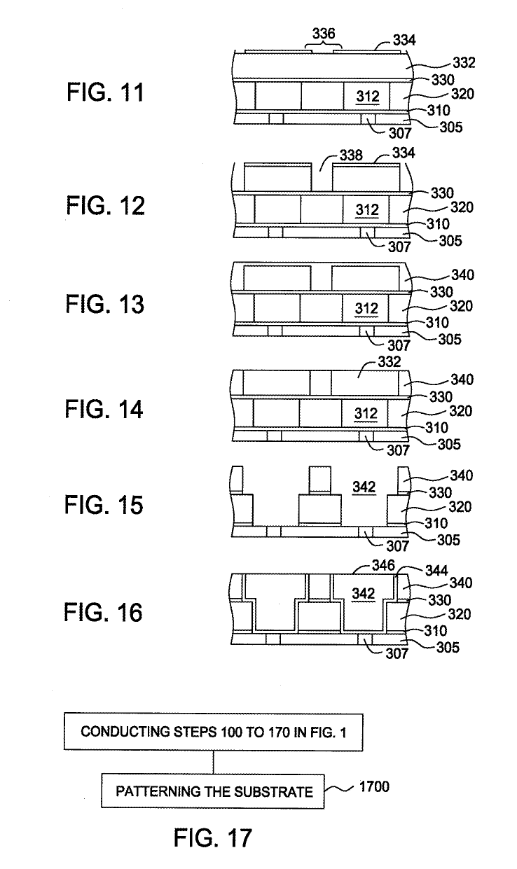

In another embodiment of the damascene structure, a dual damascene structure may be formed using the negative mask material and etch resistant material described herein. The sequence is partially depicted schematically in FIG. 2 and FIGS. 11-16. FIGS. 11-16 are cross sectional views of a substrate having the Steps 200-290 of the flowchart of FIG. 2 performed thereof. The flow chart of FIG. 2 is provided for illustrative purposes and should not be construed as limiting the scope of the invention.

A substrate is prepared at Steps 100-160 as shown in FIG. 6. An optional barrier layer/etch stop 330 is deposited on the negative mask material 312 and etch resistant materials 320 of the substrate. A second negative mask material 332 is deposited on the barrier layer/etch stop 330 at Step 200 and a second resist material 334 is deposited and patterned to indicate the width of the second, or trench, level feature definition 336 at Step 210 as shown in FIG. 11. The barrier layer/etch step may comprise the same material as barrier layer 310, such as silicon carbide based barrier layer or another material, such as silicon nitride. The second negative mask material layer 332 may be deposited in the same manner and of the same material as the negative mask material 312 described herein. The second resist material 334 may comprise the same material as resist material 314 and be patterned with the same conventional photolithography processes.

The negative mask material 332 is then etched using reactive ion etching or other conventional etching techniques to define the negative mask feature definitions 338 at Step 220 and as illustrated in FIG. 12. The negative mask material 332 may be etched by the same or similar etching process as used for the negative mask material 312 etching process. Any second resist material 334 or other material used to pattern the negative mask material 332 is removed using an oxygen strip or other suitable process at Step 230.

A second etch resistant material 340 is then deposited on the substrate 300 to fill in the negative mask feature definitions 338 at Step 240 as illustrated in FIG. 13. The second etch resistant material may comprise the same etch resistant material as used for etch resistant material 320.

The etch resistant material 340 is then polished to expose the underlying second negative mask material 332 at Step 250 as illustrated in FIG. 14. The polishing process may be any conventional chemical mechanical polishing process, or an electrochemical mechanical polishing process known in the art for removing such materials, and may be the same polishing process as used in Step 160.

The negative mask material 312 and second negative mask material 332 are then etched using reactive ion etching or other conventional etching techniques, such as described herein at Step 170, to be removed from the substrate and define the etch resistant material negative mask feature definitions 342 at Step 260 and as illustrated in FIG. 15. Optionally, the substrate may then be exposed to a reactive pre-clean process at Step 270 to remove some oxides and other contaminants, such as etch residue and metal contaminants, in the definition 342 as described in Step 180 herein.

Conductive fill materials including a barrier layer 344 and then a conductive material layer 346 are deposited on the exposed surface of the feature definition 342 at Step 280 to form conductive material features. The barrier layer 344 and the conductive material layer 346 may comprise the same material as described for the barrier layer 322 and conductive material 324 herein.

The deposited barrier layer 344 and conductive material layer 346 may be further processed by planarizing the top portion of the feature definition 342 to expose the etch resistant material 340 and form the conductive material features, by a chemical mechanical polishing process or electrochemical mechanical polishing process at Step 290 as shown in FIG. 16. An example of an electrochemical polishing process is described in co-pending U.S. patent application publication No. 2003/0178320, published on Sep. 25, 2003, which is assigned to Applied Materials, Inc., and is incorporated herein by reference to the extent not inconsistent with the invention.

A passivation layer, (not shown) such as a dielectric barrier material as used for barrier layer 310 or 330 may be deposited over the planarized substrate surface.

Use of the Etch Resistant Mask as Selective Dryetch Hardmask

In another embodiment the etch resistant material as described herein may be used as a highly selective dryetch hardmask. The sequence is depicted in the flow chart of FIG. 17. The flow chart of FIG. 17 is provided for illustrative purposes and should not be construed as limiting the scope of the invention.

A substrate is prepared at Steps 100-170. After etching the negative mask material to form the etch resistant material feature definitions, the etch resistant material feature definitions are used as a hardmask, in Step 1700, allowing for selective removal of the underlying material on the substrate. The hardmask provides a selectivity, or removal rate ratio, of substrate material to etch resistant material of about 100:1 or greater. The reduced rate of removal of the etch resistant material allows for effective conductive material etch without loss of the etch resistant material which defines the definitions of the features being etched into the substrate material. The hardmask may be removed by a polishing process such as any conventional chemical mechanical polishing process, or an electrochemical mechanical polishing process known in the art for removing such materials.

While the foregoing is directed to preferred embodiments of the present invention, other and further embodiments of the invention may be devised without departing from the basic scope thereof, and the scope thereof is determined by the claims which follow.

1. A method of processing a substrate, comprising:
depositing a negative mask material on a surface of the substrate;
depositing a resist material on the negative mask material;
patterning the resist material to expose the negative mask material;
etching the exposed negative mask material to form negative mask feature definitions;
removing the resist material;
depositing an etch resistant material in the negative mask feature definitions and on the negative mask material;
polishing the etch resistant material to expose the negative mask materials; and
etching the negative mask material to form feature definitions in the etch resistant material.

2. The method of claim 1, wherein the negative mask material is selected from the group of polysilicon, silicon carbide, amorphous silicon, silicon nitride, amorphous carbon, parylene, silicon oxide, carbon doped silicon oxide, un-doped silicon glass, fluorine-doped silicon glass, and combinations thereof.

3. The method of claim 1, wherein the etch resistant material comprises a ceramic material.

4. The method of claim 3, wherein the ceramic material is selected from the group of aluminum oxide, aluminum carbide, and combinations thereof.

5. The method of claim 1, wherein the surface of the substrate comprises conductive features formed in a dielectric material.

6. The method of claim 1, further comprising depositing a dielectric barrier layer on the substrate surface prior to the depositing the negative mask material.

7. The method of claim 1, further comprising:
depositing a filler material in the etch resistant material feature definitions; and
polishing the filler material to expose the etch resistant material.

8. The method of claim 7, wherein the depositing the filler material comprises:
depositing a barrier layer material; and
depositing a conductive material layer thereon.

9. The method of claim 8, wherein the barrier layer material is selected from the group of titanium, titanium nitride, titanium silicon nitride, tungsten nitride, tungsten silicon nitride, tantalum, tantalum nitride, tantalum silicon nitride, niobium, niobium nitride, vanadium, vanadium nitride, ruthenium, ruthenium nitride, and combinations thereof, and the conductive material comprises copper or tungsten.

10. The method of claim 8, wherein the polishing the filler material comprises polishing the conductive material and the barrier layer in one or more processing steps to expose the etch resistant material.

11. The method of claim 10, where in the polishing the filler material comprises polishing in one or more steps using a chemical mechanical polishing technique, a electrochemical polishing technique, or combinations thereof.

12. The method of claim 1, wherein the filler material comprises polysilicon.

13. The method of claim 1, wherein the negative mask material has an etch selectivity of negative mask material to etch resistant material of about 100:1 or greater.

14. The method of claim 1, further comprising patterning the substrate after etching the negative mask material to form feature definitions in the etch resistant material.

15. The method of claim 1, further comprising:
depositing a second negative mask material on the negative mask material and the etch resistant material;
depositing a second resist material on the second negative mask material;
patterning the second resist material;
etching the exposed second negative mask material to the substrate surface to form second negative mask feature definitions;
removing the resist material;
depositing a second etch resistant material in the second negative mask feature definitions;
polishing the second etch resistant material to expose the second negative mask material; and
etching the first and second negative mask materials to form feature definitions in the first and second etch resistant materials.

16. The method of claim 15, wherein the negative mask material and second negative mask material are the same material.

17. The method of claim 15, wherein the second negative mask feature definitions are wider than the first negative mask feature definitions.

18. The method of claim 15, wherein the etch resistant material and second etch resistant material are the same material.

19. The method of claim 1, further comprising exposing the substrate surface to a plasma after etching the negative mask material to form feature definitions.

20. A method of processing a substrate, comprising:
depositing a barrier layer on the substrate;
depositing a first negative mask material on the barrier layer;
depositing a first resist material on the negative mask material;
patterning the first resist material to expose the first negative mask material;
etching the exposed first negative mask material to form first negative mask feature definitions;
removing the first resist material;
depositing a first etch resistant material in the negative mask feature definitions and on the first negative mask material;
polishing the first etch resistant material to expose the first negative mask materials;
etching the first negative mask material to form feature definitions in the etch resistant material;
depositing a second negative mask material on the negative mask material and the etch resistant material;
depositing a second resist material on the second negative mask material;
patterning the second resist material;
etching the exposed second negative mask material to the substrate surface to form second negative mask feature definitions;
removing the resist material;
depositing a second etch resistant material in the second negative mask feature definitions;
polish the second etch resistant material to expose the second negative mask material; and
etching the first and second negative mask materials to form feature definitions in the first and second etch resistant materials.

21. The method of claim 20, wherein the negative mask material comprises polysilicon, silicon carbide, amorphous silicon, silicon nitride, amorphous carbon, parylene, silicon oxide, carbon doped silicon oxide, un-doped silicon glass, fluorine-doped silicon glass, and combinations thereof.

22. The method of claim 20, wherein the etch resistant material comprises a ceramic material.

23. The method of claim 22, wherein the ceramic material is selected from the group of aluminum oxide, aluminum carbide, and combinations thereof.

24. The method of claim 20, wherein the first negative mask material and second negative mask material are the same material.

25. The method of claim 20, wherein the second negative mask feature definitions are wider than the first negative mask feature definitions.

26. The method of claim 20, wherein the etch resistant material and second etch resistant material are the same material.

27. The method of claim 20, further comprising depositing a second barrier layer on the negative mask material and the etch resistant materials of the substrate prior to depositing a second negative mask material on the negative mask material and the etch resistant material.
